(19) United States
(12) Patent Application Publication
(10) Pub. No.: US 2007/0000302 A1
(43) Pub. Date: Jan. 4, 2007

(54) Method for testing the function of a hydraulic valve and a test bench for carrying out said method

(76) Inventors: Thomas Gramkow, BERLIN (DE); Peter Schmidt, Berlin (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/549,741

(22) PCT Filed: Jan. 24, 2004
(86) PCT No.: PCT/EP04/00587

§ 371 Date: Aug. 31, 2006

(30) Foreign Application Priority Data
Mar. 19, 2003 (DE) 103 12 087.4

(51) Int. Cl. G01L 27/00

(52) U.S. Cl. 73/1.71

(57) ABSTRACT

A method for testing the function of a hydraulic valve (1) and a test stand (31) for carrying out the method are proposed. The method is distinguished in that a pressurized gaseous medium is used as a test medium.

### BACKGROUND OF THE INVENTION

1. Field of the Invention

The invention relates to a method for testing the function of a hydraulic valve, as claimed in claim 1, and to a test bench for testing the function of hydraulic valves, as claimed in claim 13.

2. Related Art of the Invention

Hydraulic valves which are designed as proportional valves and are used, for example, for the hydraulic activation of camshaft timing systems are known. A proportional valve of this type has a pressure connection, at least one reservoir connection, at least one consumer connection and a control piston which is mounted movably in a control cylinder and is prestressed by means of a spring and which serves for controlling the volumetric flow of a hydraulic medium. The control piston is moved by means of magnetic force. For this purpose, a magnetic part is used which is capable of being acted upon with current and which co-operates with the control piston. The magnetic force changes as a function of the magnitude of the electrical current, with the result that the control piston position and therefore also the volumetric flow flowing through the hydraulic valve also change proportionally.

For the purpose of testing the function of the proportional valve, the hydraulic medium employed during the later use of the proportional valve is introduced under pressure into the latter and its volumetric flow is plotted against the distance covered by the control piston or against the current applied to the magnetic part. The volumetric flow characteristic curve thus transmitted must then lie within defined limits. If this is not so, the proportional valve is, if appropriate, adjusted or remachined. The test of the function of the hydraulic valve often takes place during the manufacturing process, and therefore impurities caused by the hydraulic test medium may occur there. There is also the disadvantage of relatively long test times, with the result that the cycle time for the production of the hydraulic valves in mass production is correspondingly high. Furthermore, complicated test equipment is required.

### SUMMARY OF THE INVENTION

The object of the invention is to provide a method of the type initially mentioned, in which high functional reliability can be ensured. A further aim of the invention is to provide a test bench for carrying out the method.

To achieve the object, a method having the features of claim 1 is proposed. There is provision for using a pressurized gaseous medium as the test medium for testing the function of a hydraulic valve. Air is preferably used as the test medium. As a the result of the pneumatic testing of the hydraulic valve, the test time can be reduced markedly, as compared with the known test methods, since, in particular, the connection of the hydraulic valve to a test medium supply is markedly simpler. The further advantage is that, owing to the use of a gaseous test medium, no oil impurities caused by the function test arise during the manufacturing process.

The method according to the invention can be employed particularly advantageously for testing the function of hydraulic proportional valves, in particular proportional directional valves, in particular for the hydraulic activation of camshaft timing systems. The test method is, of course, not restricted to this special type of hydraulic valves, but can basically be employed universally for hydraulic valves.

Advantageous embodiments of the method may be gathered from combinations of the features mentioned in the subclaims.

The subject of the invention is also a test bench for testing the function of hydraulic valves, which is suitable for carrying out the method as claimed in one of claims 1 to 12. The pneumatic test bench for testing the function of hydraulic valves has, in particular, the advantage that, owing to the gaseous test medium used, impurities in the surroundings can be ruled out. The test bench can therefore be integrated readily into the manufacturing process of the hydraulic valves.

### BRIEF DESCRIPTION OF THE DRAWINGS

The invention is explained in more detail below with reference to the drawing in which:

FIG. 1 shows a partially sectional view of an exemplary embodiment of a magnetically actuable hydraulic valve;

FIG. 2 shows a view of a hydraulic part, arranged in a test block, of the hydraulic valve according to FIG. 1;

FIG. 3 shows a graph, in which the volumetric flow characteristic curve of the hydraulic valve according to FIG. 1, acted upon by a gaseous test medium, is plotted against time;

FIG. 4 shows a graph, in which the force applied to a control piston, acted upon by a spring force, of the hydraulic valve according to FIG. 1 is plotted against time;

FIG. 5 shows a graph, in which the force/hysteresis characteristic curve of the hydraulic valve according to FIG. 1 is plotted, and

FIG. 6 shows a detail of an exemplary embodiment of a test bench for testing the function of hydraulic valves.

### DETAILED DESCRIPTION OF THE INVENTION

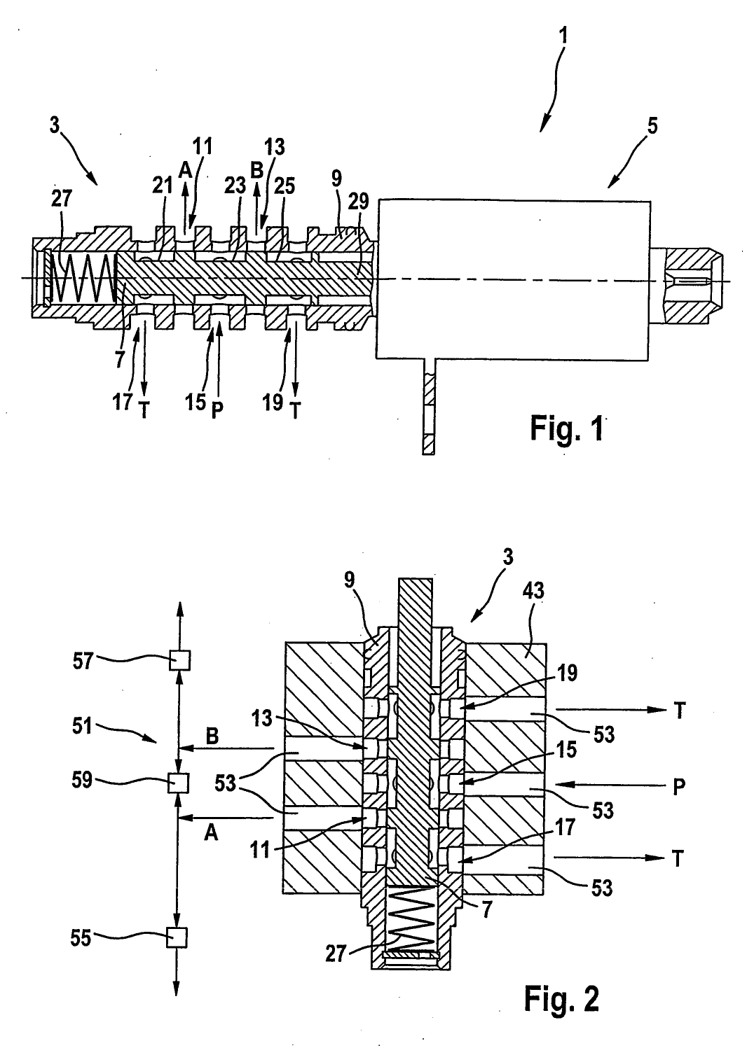

FIG. 1 shows part of an exemplary embodiment of an electrohydraulic proportional directional valve, referred to briefly below as a hydraulic valve 1, which comprises a hydraulic part 3 and a magnetic part 5. The construction and function of the hydraulic valve 1 are generally known, therefore these are dealt with only briefly below.

The hydraulic part 3 comprises a control element which is formed by a control piston 7 and which is arranged axially displaceably in a control cylinder 9. The control cylinder 9 is provided, inter alia, with control bores 11, 13, 15, 17 and 19 which are controlled by the control piston 7. In this exemplary embodiment, the control cylinder 9 has further control bores, not designated, the function of which is not dealt with here in any more detail.

The control bore 11 forms a consumer connection A and the control bore 13 a consumer connection B which, in each case via a suitable medium connection, can be connected, for example, in each case to a working space of a cylinder. The control bore 15 forms a pressure connection P to which a pressure medium pump is connected. The control bores 17 and 19 form respective reservoir connections T which can be connected to a tank. To control the throughflow quantity, the control piston 7 has control grooves 21, 23 and 25, by means of which the pressure connection P is connected to the consumer connection A or B and the consumer connection A or B is connected to the reservoir connection T, depending on the position of the control piston 7.

The control piston 7, at its end facing away from the magnetic part 5, is acted upon with force by a compression spring 27 which presses the control piston 7 in the direction of the magnetic part 5, if appropriate against a stop. The control piston 7, at its end on the magnetic-part side, has a tenon 29, at which it can be acted upon by means of the magnetic part 5 with a pressure force acting counter to the force of the spring 27.

The magnetic part 5 is formed, here, by a pressing proportional magnet, also designated as a pressure magnet, which comprises an armature tappet, on which a magnet armature is fastened and is guided axially displaceably in a winding space of a magnet coil. When a current is applied to the magnet coil at an electrical connection, the magnet armature moves in the magnetic field of the magnetic coil toward a pot-shaped pole core of a magnetic flange. In this case, the armature tappet is laid, on the end face, against the tenon of the control piston 7 and adjusts the latter according to the application of current of the magnet coil, counter to the force of the compression spring 27, at most as far as a limit stop, not illustrated in FIG. 1.

In FIG. 1, the control piston 7 is arranged in a middle position, in which it shuts off the passage from the pressure connection P to the consumer connections A, B and the reservoir connections T.

For the pneumatic testing of the function of the hydraulic part 3 of the hydraulic proportional valve described with reference to FIG. 1, a test bench 31 is provided, an exemplary embodiment of which is depicted in FIG. 6. The test bench 31 comprises a baseplate 33, on which is arranged a profile column 35 which runs perpendicularly with respect to the latter and on which a linear drive 37 is fastened. With the aid of the linear drive 37, which may comprise, for example, a spindle with a servomotor, an adaption element 39 formed by an angle can be moved perpendicularly with respect to the flat side of the baseplate 33, that is to say in a vertical direction. The adaption element 39 has provided on it a pin-shaped, here resiliently mounted contact element 41 which co-operates directly with the control piston 7, that is to say, in the event of a movement of the adaption element 39 by means of the linear drive 37, the contact element 41 displaces the control piston 7 in the axial direction within the control cylinder 9. The hydraulic part 3 itself is located in a test block 43 which is explained in more detail below with reference to FIG. 2. The test block 43 is arranged on an adaptor plate 47 which is mounted on rails 45 and which can be arranged in an exact position on the baseplate 33 by means of a fixing device 49. The fixing device 49 has, here, a locking pin which is arranged on the adaptor plate 47 and which can be moved into at least one passage orifice provided in a rail arranged in a fixed position with respect to the baseplate 33. Furthermore, the test bench 31 has a valve device 51, indicated diagrammatically in FIG. 2, and can be connected to a compressed air supply device by means of corresponding pressure and vent lines/ducts. The compressed air supply may be part of the test bench 31.

The test bench 31 is equipped, furthermore, with a measuring device, not illustrated in the figures, which has a measuring computer, a volumetric flow sensor, in particular laminar flow element, a tension/pressure force sensor, a temperature sensor for detecting the test-medium and/or ambient temperature, a pressure sensor for the pressure connection P and, if appropriate, a displacement sensor.

FIG. 2 shows a longitudinal section through the test block 43, into which the hydraulic part 3 is adapted, leakage-free, by means of expansion sealing-off elements, not illustrated in FIG. 2. A separation of the hydraulic part 3 and magnetic part 5 is not absolutely necessary for the pneumatic testing of the function of the hydraulic part 3. However, if the hydraulic part 3 is separated from the magnetic part 5 for the purpose of the function test, control piston force measurement may additionally be carried out, with the result that the friction in the hydraulic part 3 can be detected or measured.

As is evident from FIG. 2, the test block 43 is provided with ducts 53 which issue on its outside and which are assigned in each case to one of the control bores 11 to 19. The cross sections of the test adaption ducts 53 through which the gaseous test medium flows, preferably in all the further pressure and vent lines/ducts of the valve device 51, are at least of equal size to or larger than the throughflow cross sections in the hydraulic part 3.

FIG. 2 indicates by means of arrows that in each case a pressure or vent line can be connected to the ducts 53. In order to connect the consumer connections A, B selectively to the atmosphere or to one another in each case jointly or independently of one another, the valve device 51 has a first solenoid valve 55, a second solenoid valve 57 and a third solenoid valve 59.

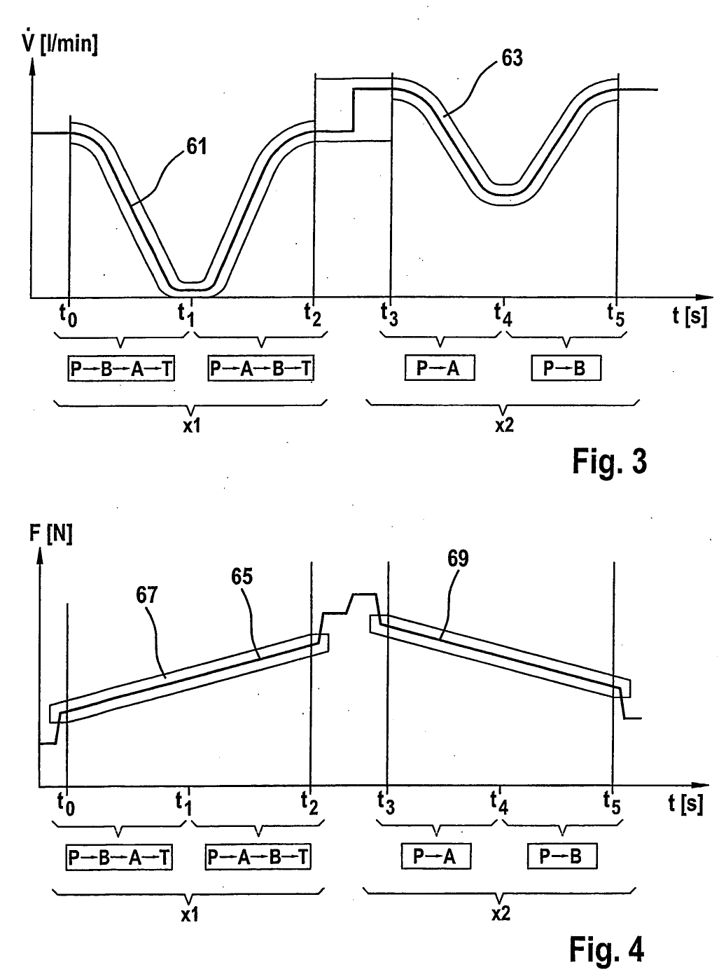

A test sequence capable of being implemented by means of the test bench 31 is explained in more detail below with reference to FIG. 3: For preparation, the hydraulic part 3 is adapted in the test block 43, the test block 43 is introduced into the test bench 31 and the valve device 51 is connected to the test block 31. The pressure connection P is then acted upon by the gaseous test medium which is under a regulated test pressure. By means of the linear drive 37, the control piston 7 is displaced out of an initial position, which may be an end position defined by a stop, into a second position, which may likewise be a second end position defined by a stop. This first stroke of the control piston 7 is identified in FIG. 3 by x1. During the execution of the first stroke x1, the valve device 51 is switched in such a way that there is a short circuit between the consumer connections A and B. After the first stroke x1 has been executed, the solenoid valves 55 to 59 are switched in such a way that the consumer connections A and B are connected to the atmosphere. The control piston 7 is then displaced out of the second position back into the initial position and at the same time executes a second stroke x2. During the movement of the control piston 7 back and forth, the volumetric flow is detected at a predetermined sensing rate by means of the volumetric flow sensor. The volumetric flow characteristic curve determined thereby is given the reference numeral 61. Furthermore, FIG. 3 depicts a tolerance band 63 which indicates the respectively permissible upper and lower limits of the volumetric flow in a specific position in the control piston 7.

The following manufacturing errors or properties of the hydraulic part 3 can be detected by means of the abovementioned pneumatic test method and the volumetric flow characteristic curve thus determined:

gap between the control piston 7 and control cylinder 9,

absent bores/ducts in the control piston 7 and control cylinder 9,

errors in the overlap of the control edges between the control piston 7 and control bores 11 to 19, including edge breaks,

offset middle position of the control piston 7,

stroke of the control piston 7, and

closing of the control piston 7.

While the control piston 7 is executing the first stroke x1, the consumer connections A, B are short-circuited with one another by means of the valve device 51, so that the pressure medium flows first from the pressure connection P via the consumer connection B to the consumer connection A and from there to the reservoir connection T (P→B→A→T). As is evident from FIG. 3, the volumetric flow is very high at the time t0 in the initial position of the control piston 7 and reaches a minimum at the time t1 in the middle position of the control piston 7. After the middle position has been passed, the volumetric flow rises again until the second control piston position 7 is reached at the time t2. In this case, the test medium flows from P via A toward B and from there toward T (P→B→A→T).

After the first stroke x1 has been executed, the switching of the valve device 51 is changed in such a way that the consumer connections A, B are then connected to the atmosphere, that is to say the test medium is blown off into the surroundings via the consumer connections A, B. The control piston 7 is in the second position at the time t3 and is then displaced back, passing through its middle position at the time t4 and reaching its initial position again at the time t5. It is readily evident from FIG. 3 that, by the compressed air being blown off into the atmosphere via the consumer connections A, B, the volumetric flow flowing through the hydraulic part 3 is markedly higher than when the consumer connections A, B are short-circuited. The reason for this is that the frictional losses for the consumer connection A or B are reduced by the compressed air being blown off. Owing to the higher volumetric flow, edge breaks and control edge overlap errors can be detected more effectively.

It remains to be said that, in the test method described above, the valve displacement is executed twice (double function test). Since in this case the volumetric flow characteristic curve 61 is plotted both as a complete throughflow (P→B→A→T) or (P→A→B→T) and as a part throughflow (P→A or P→B) of the hydraulic part 3, a highly accurate test result can be achieved.

FIG. 4 shows a graph in which a force characteristic curve 65 determined by means of the tension/pressure force sensor during the test operation described above is plotted against time t. Furthermore, tolerance bands 67 and 69 for the force in the region of the back and forth movements (x1, x2) of the control piston 7 are depicted. In the graph, therefore, the force to be applied for displacing the control piston 7 out of its initial position into the second position and back again into the initial position can be gathered against time. If the displacement of the control piston 7 takes place at a constant speed, this being preferred, the spring characteristic curve of the compression spring 27 can readily be determined from this. Furthermore, a jamming/tilting of the control piston 7 can be detected.

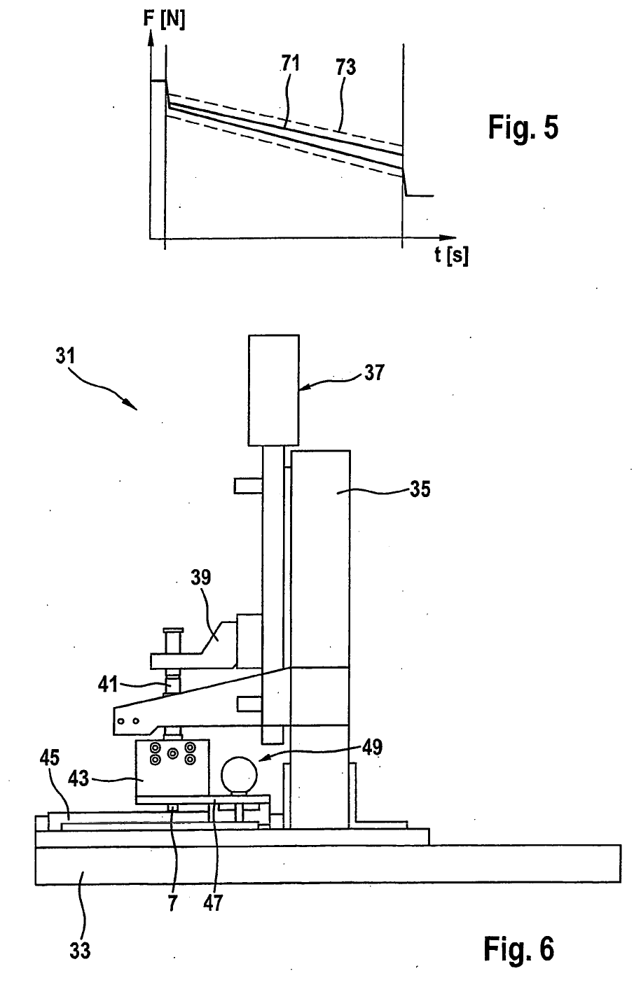

FIG. 5 shows a graph in which the force/hysteresis characteristic curve 71 of the hydraulic part 3 and, by broken lines, the associated predetermined tolerance band 27 are depicted. By means of the force/hysteresis characteristic curve 71 which is calculated from the force characteristic curve 65 according to FIG. 4 over time, a jamming of the control piston 7 can be detected and evidence can be obtained on the roughness of the surface of the bore receiving the control piston 7, in the control cylinder 9 and of the guide surface of the control piston 7.

The characteristic curves and tolerance bands shown in FIGS. 3 to 5 are representative of the 4/2-way proportional valve 1 described with reference to FIG. 1, in which, as described, the volumetric flow characteristic curve 61 reaches a minimum value, starting from a maximum throughflow value with the valve fully open, and rises again after the shut-off position (middle position) has been passed, until the maximum throughflow, this time in the opposite flow direction, is reached again. In other embodiments of the hydraulic valve, characteristic curves having a correspondingly different profile are obtained.

In the test method described with reference to the figures, measurement data detection and/or measurement data evaluation are readily possible online, that is to say even during the test operation, so that correspondingly short test times can be achieved. The characteristic values or characteristic curves determined are compared with permissible predetermined limit values, which may take place automatically by means of the measuring device.

It remains to be said that, to ascertain whether a hydraulic valve conforms or just still conforms to its set requirement, it may be sufficient to determine only the volumetric flow or only the test force against time and/or displacement. The costs of the test bench 31 can thereby be reduced by special sensors being correspondingly dispensed with.

Instead of air, another gaseous medium may also readily be used as the test medium.

1-13. (canceled)

14. A method for testing the function of a hydraulic valve (1), which has a pressure connection (P), at least one reservoir connection (T), at least one consumer connection (A, B) and a displaceable control piston (7) for controlling the volumetric flow (\dot{V}) of a pressure medium flowing from the pressure connection (P) to the reservoir connection (T) or consumer connection (A, B), comprising:
using a pressurized gaseous medium as the test medium, which is introduced into the hydraulic valve (1) at the pressure connection (P),
setting the pressure of the gaseous medium to be constant during the testing,
wherein to test the hydraulic valve (1) the control piston (7) is displaced out of an initial position into a second position and out of the second position back again into the initial position, and
wherein the displacement speed of the control piston (7) during the testing of the hydraulic valve (1) is constant.

15. The method as claimed in claim 14, wherein the control piston (7) has a first consumer connection (A) and a second consumer connection (B), and wherein, during the displacement of the control piston (7) out of the initial position into the second position, the consumer connections (A, B) are medium-connected to one another.

16. The method as claimed in claim 15, wherein, during the displacement of the control piston (7) out of the second position back into the initial position, the first and second consumer connections (A, B) are in each case connected to the atmosphere.

17. The method as claimed in claim 14, wherein, during the displacement of the control piston (7) out of the initial position into the second position and out of the second position back again into the initial position, the volumetric flow (\dot{V}) of the gaseous test medium is determined as a function of the time (t) and/or of the distance (x1, x2) covered by the control piston (7), and wherein the volumetric flow values/characteristic curve or curves determined are compared with desired and/or limit values or with at least one desired and/or limit value characteristic curve.

18. The method as claimed in claim 14, wherein the control piston (7) is acted upon or can be acted upon with force by means of at least one spring element (27), in that, during the displacement of the control piston (7) out of the initial position into the second position and out of the second position back again into the initial position, the force (F) to be applied for this purpose is determined as a function of the time (t) and/or of the distance (x1, x2) covered by the control piston (7), and in that the force values/characteristic curve or curves determined are compared with desired and/or limit values or with at least one desired and/or limit value characteristic curve.

19. The method as claimed in claim 18, further comprising determining the force/hysteresis characteristic curve of the hydraulic valve (1).

20. The method as claimed in claim 19, wherein the force/hysteresis characteristic curve of the hydraulic valve (1) is calculated from the plotted values of the force (F) to be applied for displacing the control piston (7) out of the initial position into the second position or out of the second position into the initial position.

21. The method as claimed in claim 14, wherein the sensing rate of the volumetric flow (\dot{V}) or of the force (F) applied to the control piston (7) can be set during the testing operation.

22. The method as claimed in claim 14, wherein measurement data detection and/or measurement data evaluation takes place online.

23. A test bench (31) which has a pressure connection (P), at least one reservoir connection (T), at least one consumer connection (A, B) and a displaceable control piston (7) for controlling the volumetric flow (\dot{V}) of a pressure medium flowing from the pressure connection (P) to the reservoir connection (T) or consumer connection (A, B), said test bench (31) is adapted to carry out a method for testing the function of hydraulic valves (1) comprising:
using a pressurized gaseous medium as the test medium, which is introduced into the hydraulic valve (1) at the pressure connection (P),
setting the pressure of the gaseous medium to be constant during the testing,
wherein to test the hydraulic valve (1) the control piston (7) is displaced out of an initial position into a second position and out of the second position back again into the initial position, and
wherein the displacement speed of the control piston (7) during the testing of the hydraulic valve (1) is constant.
